(19) United States
(12) Patent Application Publication
(10) Pub. No.: US 2007/0012399 A1
(43) Pub. Date: Jan. 18, 2007

(54) Segmented pultrusion die and method of making same

(76) Inventor: Andrew Rekret, Toronto (CA)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 11/487,191

(22) Filed: Jul. 14, 2006

Related U.S. Application Data
(60) Provisional application No. 60/699,465, filed on Jul. 15, 2005.

(30) Foreign Application Priority Data
Mar. 9, 2006 (CA) CA 2,539,465

(51) Int. Cl. B29C 65/00

(52) U.S. Cl. 156/304.2; 249/117

(57) ABSTRACT

There is disclosed a method of making a segmented pultrusion die, said method comprising the steps of: selecting a first block having a first length sized to permit end cutting along an axis of said first block; end cutting said first block along said axis thereof, to form a first die segment having a first cavity extending therethrough, said first cavity having a first cross-sectional profile, selecting a second block having a second length; processing said second block to form a second die segment having a second cavity extending therethrough, said second cavity having a second cross-sectional profile which matches said first cross-sectional profile; aligning said first and said second die segments together to match said first cross-sectional profile together with said second cross sectional profile to form a continuous die having a constant cross-sectional profile; and securing said aligned first and second die segments together to permit said segmented pultrusion die to be used in place of a single die. Also disclosed is a segmented pultrusion die comprising a first die segment, a second die segment, said first die segment being adjoined to said second die segment, and a means for securing the first die segment to the second die segment.

### FIELD OF THE INVENTION

The present invention relates to methods and devices to make plastic molded articles by a pultrusion process. In particular this invention relates to methods and devices to make dies suitable for use in pultrusion processes.

### BACKGROUND OF THE INVENTION

Pultrusion is a well-established and cost effective manufacturing process for producing continuous runs of molded composite articles of a resin matrix reinforced with a fiber substrate. In this form of plastic molding, the molded article is drawn or pulled through the mold as a continuous article having an engineered profile. The profile is determined by the shape of the mold. At the input end of the mold, the fiber substrate is typically quite loose and flexible. Then a liquid resin is applied in a die and curing occurs as the compound article passes through the mold. The curing has to be sufficiently complete to permit a tractor grip or other type of pulling device to be used to pull the continuous article through the mold from the downstream end. To let the article cure or harden enough for pulling requires a slower feed rate, to permit more curing time in the mold, or longer molds, to permit faster feed rates but longer residence times in the mold for curing.

An expensive element of any pultrusion molding line is the pultrusion die, which is used to form the desired profile in the continuous molded article and is also used to cure the resin impregnated fiber substrate, by subjecting the substrate to a predetermined curing temperature for enough time to permit the article to harden for pulling. A typical pultrusion die is three feet or more in length. Such length imposes certain constraints upon how the die is made which in turn has certain cost consequences for making the die. For example, for a hollow die of this length it is necessary to fabricate the die from two halves, where the join line is along the long axis of the die. Thus, each half or mold part is formed separately from a block of for example steel. By separating the die into two longitudinal halves, each mold part has a face into which a profile is cut transverse to the longitudinal axis. The profile cut into each mold part represents one half of the overall engineered profile desired in the finished article. The two mold parts are then joined together sideways (like a clam shell) with the two grooves carefully axially aligned to match. The result is a pultrusion die with a cavity extending through its full length. The cavity thus formed has a predetermined cross-sectional profile as a result of the combination of the matching transverse-cut shaped grooves.

Forming the shaped grooves is a very expensive, time consuming and unforgiving process, because the profiles have to match exactly when placed together. The typical mode of fabrication is precision grinding, which is possible because the whole side of the mold part is accessible to a precision grinding machine to permit the transverse cut. The grinding process may take weeks to complete and if it turns out that the resulting cavity of the completed pultrusion die does not have the correct cross-sectional profile, then the whole process must be repeated at further cost and with further delay. What is difficult is to get each transversely formed groove to bean exact match to the other so as to produce asymmetrical pultruded article from the mold.

Pultrusion production of articles is a process which is subject to many variables, such as drawing or pulling speed, resin composition, profile shape and size, curing aspects such as temperature control and duration, and die length and shape. The expense of the dies used in pultrusion process limits the producers ability to modify and alter the profile to accommodate one or other of the variables to optimise the molded finished product. The die expense has therefore limited the flexibility of pultrusion equipment to be adjusted to optimise finished articles and the overall quality of pultruded articles is less than is desirable, due to the need to make due with an expensive, but perhaps imperfect, die.

What is desired is a simple, fast, and cost efficient pultrusion die and method of making the same, that can be used to pultrude a fiber-reinforced resin matrix.

### SUMMARY OF THE INVENTION

One aspect of the present invention is to provide a method of making a segmented pultrusion die, said method comprising the steps of:

selecting a first block having a first length sized to permit end cutting along a longitudinal axis of said first block;

end cutting said first block along said longitudinal axis to form a first die segment having a first cavity extending therethrough, said first cavity having a first cross-sectional profile,

selecting a second block having a second length,

processing said second block to form a second die segment having a second cavity extending therethrough, said second cavity having a second cross-sectional profile which matches said first cross-sectional profile;

aligning said first and said second die segments together to match said first cross-sectional profile together with said second cross sectional profile to form a continuous die having a constant cross-sectional profile; and

securing said aligned first and second die segments together to permit said segmented pultrusion die to be used in place of a single die.

In another aspect, there is provided a segmented pultrusion die made by the method above method.

In yet another aspect, there is provided a segmented pultrusion die comprising:

a first die segment having a first cavity extending therethrough formed by end cutting a first block along an axis thereof; said first block having a first length sized to permit end cutting along said axis of said first block; said first cavity having a first cross-sectional profile;

a second die segment having a second cavity extending therethrough formed from a second block, wherein said second block has a second length, and wherein said second cavity has a second cross-sectional profile which is matches said first cross-sectional profile;

said first die segment being adjoined to said second die segment with said first and second cavities aligned to form a continuous die having a continuous cavity with a constant cross-sectional profile;

a means for securing said first die segment to said second die segment.

### BRIEF DESCRIPTION OF THE DRAWINGS

Reference will now be made to the preferred embodiments of the present invention with reference, by way of example only, to the following drawings in which:

FIG. 1 is a perspective view of an embodiment of the present invention showing a first die segment adjoined to a second die segment, with the adjoinment secured by a securing means;

FIG. 2 is a perspective view of the invention of FIG. 1 showing the first die segment aligned with the second die segment with pins indicated therebetween prior to the die segments being adjoined;

FIG. 3 is a perspective view of an alternate embodiment of the invention shown in FIG. 2, in which a tongue and groove is used in place of pins; and

FIG. 4 is a perspective view showing the step of end cutting a first block along an axis thereof, to form the first die segment of FIG. 1; and

FIG. 5 is a perspective view of the first die segment formed at the end of the end cutting step shown in FIG. 4.

### DETAILED DESCRIPTION OF THE PREFERRED EMBODIMENTS

The present invention is described in more detail with reference to exemplary embodiments thereof as shown in the appended drawings. While the present invention is described below including preferred embodiments, it should be understood that the present invention is not limited thereto. Those of ordinary skill in the art having access to the teachings herein will recognize additional implementations, modifications, and embodiments which are within the scope of the present invention as disclosed and claimed herein. In the figures, like elements are given like reference numbers. For the purposes of clarity, not every component is labelled in every figure, nor is every component of each embodiment of the invention shown where illustration is not necessary to allow those of ordinary skill in the art to understand the invention.

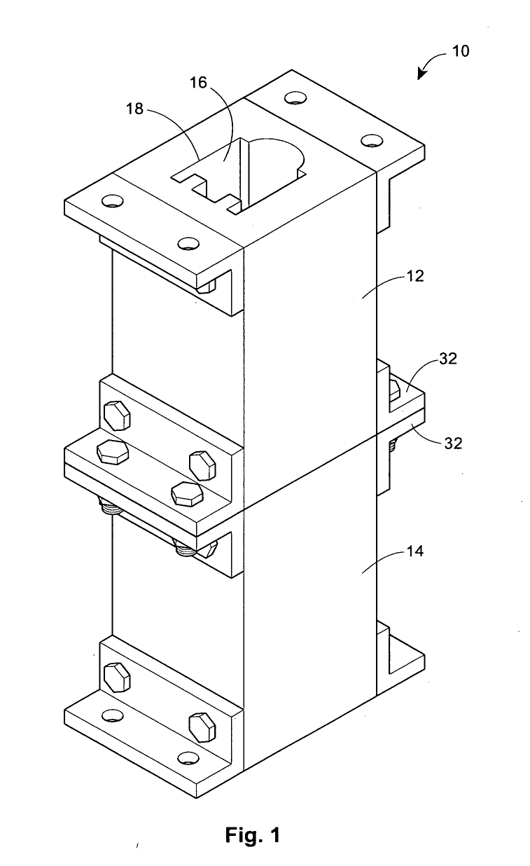

A segmented pultrustion die 10 according to the present invention is disclosed in FIG. 1. The segmented pultrusion die 10 has a first die segment 12 adjoined to a second die segment 14, and a means for securing the die segments together to form a continuous die. The first die segment 12 has a first cavity 16 extending therethrough, which has a first cross-sectional profile 18. The second die segment 14 has a second cavity 20 extending therethrough, which has a second cross-sectional profile 22 which matches the first cross-sectional profile 18. Accordingly, when the first die segment 12 is adjoined to the second die segment 14 with the first 16 and second cavities 20 aligned, the resulting segmented pultrusion die 10 will have a continuous cavity with a matching cross-sectional profile at the location of the joint.

As shown in FIG. 1 the present invention comprehends joining the die segments together along a joint line that is generally transverse to the long axis of the die, which in turn means forming the cavity in the die segment along a longitudinal axis of the die segment. Instead of combining two mold parts together to form a clamshell type of mold, the present invention joins the die segments together end to end. Although the joint is shown being on a plane orthogonal to the longitudinal axis of the mold, the joint line could be angled of even made a compound shape to facilitate the end to end interlocking of the two die segments as explained in more detail below. What is desired is to permit the overall length of the pultrusion die 10 to be built up by combining end to end at least two shorter die segments. In this way individual die segments can be fabricated where each die segment has a length that is short enough to be readily made by axially or end cutting the desired profile, or cavity into the block 34, without needing to separate the block 34 into two transverse halves.

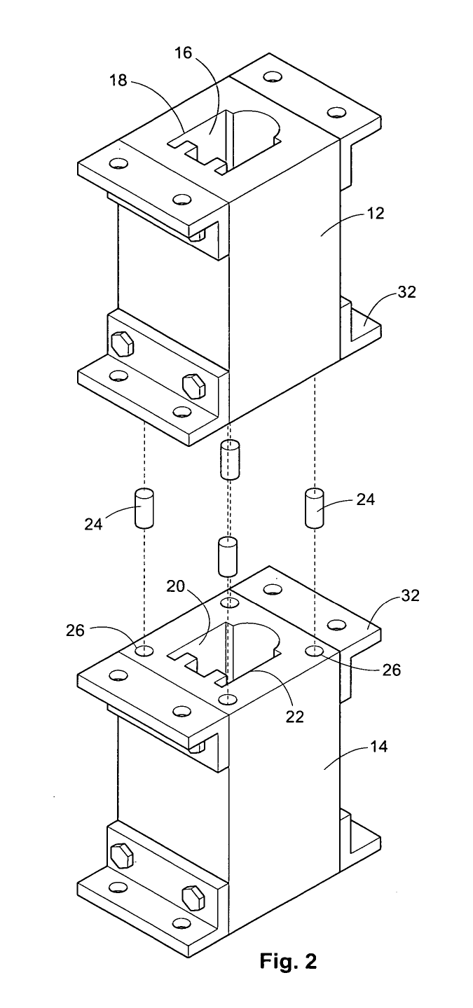

As shown in FIG. 2, and as will be appreciated by those skilled in the art, the alignment of the first 12 and second 14 die segments is accomplished by an alignment means which in one embodiment takes the form of position pins 24 that engage corresponding holes 26 in the die segments. In this embodiment the holes 26 are precisely formed in the first 12 and second 14 die segments so that when the die segments are adjoined with the position pins 24 placed therebetween to engage the corresponding holes 26, the first 16 and second 20 cavities of the first 12 and second 14 die segments will match precisely at the joint line. In this respect, while the profile of the die will typically be continuous, the present invention also comprehends cross-sectional profiles which are varied along their length, as may be required for various reasons.

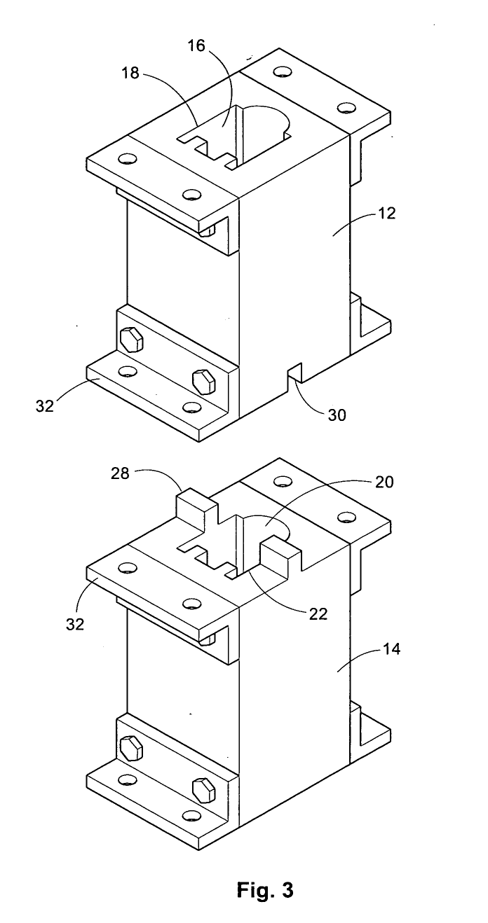

FIG. 3 shows an alternate embodiment, in which alignment of the first 16 and second 20 cavities is accomplished using an alternate alignment means which includes a tongue 28 and groove 30 system. Accordingly, one or more tongues 28 on one die segment, which in this example is the second die segment 14, are precisely positioned in matching relation to engage one or more matching grooves 30 precisely positioned on the other die segment, which in this example is the first die segment 12. As will be understood, when the first 12 and second 14 die segments are adjoined with the tongues 28 of the second die segment 14 engaging the grooves 30 of the first die segment 12, the first 16 and second 20 cavities will match precisely.

Although, two mechanisms for aligning the first 12 and second 14 die segments are herein describe, many other means for aligning the first 16 and second 20 cavities of the first 12 and second 14 die segments will be known to persons skilled in the art. These alternate means for aligning the first 16 and second 20 cavities are also comprehended by the instant invention.

FIGS. 1, 2 and 3 also show a means for securing the first die segment 12 to the second die segment 14. The securing means comprises a matching pair of attachment members 32, of which one attachment member 32 is mounted to the outer surface of the first die segment 12 proximate to an end and the other attachment member 32 is mounted to the second die segment 14 proximate to an end in matching relation.

In this example, the attachment members 32 are L-shaped, permitting one portion of the “L” to be fastened to the outer surface of one die segment, such as with threaded fasteners or the like. The other portion of the “L” is fastened to the matching attachment member 32, which is fastened on the other die segment. As will be appreciated, there are many means for securing the first die segment 12 to the second die segment 14, using various combinations of attachment members 32, threaded fasteners with matching bores, clamps and the like. Furthermore, it is contemplated that the die segments may be welded together, however, care will need to be taken during the welding process to ensure that the heat generated during welding will not warp the cross-sectional profiles 18, 22 of the die cavities 16, 20.

What is important is that the first 12 and second 14 die segments are sufficiently secured together to withstand the pressures and forces to which they will be subjected while in use in a pultrusion process.

Although, the segmented pultrusion die 10 herein described is shown with only two die segments, the instant invention also comprehends a segmented pultrusion die 10 having more than two die segments.

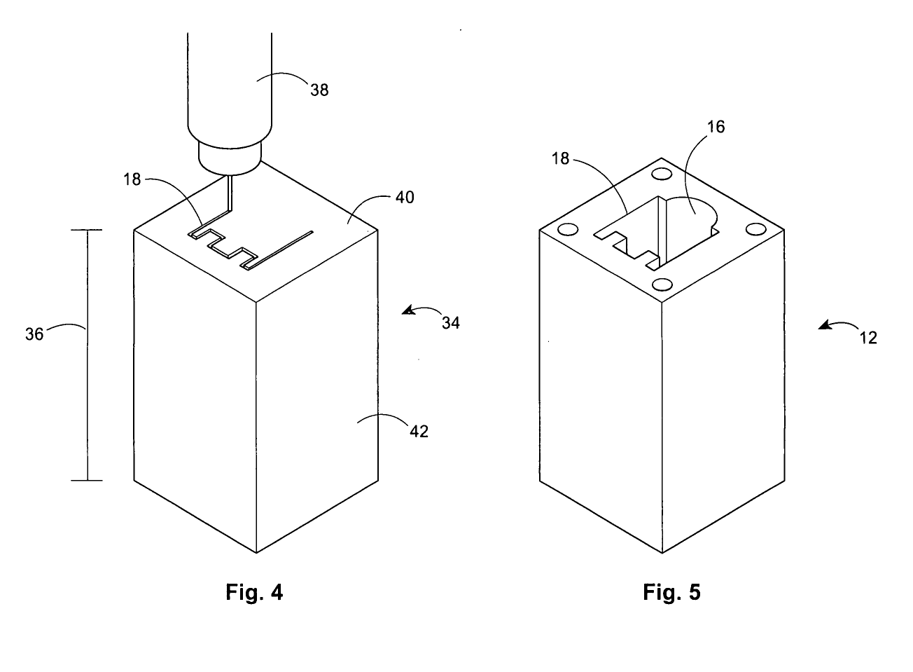

FIGS. 4 and 5 show how the die segments are made according to the present invention. Referring to FIG. 4, there is shown a block 34 having a length 36, along a longitudinal axis sized to permit end cutting along such longitudinal axis. The block 34 is preferably a steel block, although other materials which may be suitable for use in a pultrusion process as the die material may also be used as will be appreciated by those skilled in the art. A wire cutting machine 38 is shown cutting through the block 34, from one end 40, along the logitudinal axis of the block 34. This cutting process is therefore referred to as end cutting, as opposed to other cutting processes such as, for example, side or transverse cutting as in the prior art which involves cutting through a side 42 of the block 34. The wire cutting machine 38 is shown in FIG. 4, beginning to cut a cross-sectional profile 18 through a center of the block 34. The die segment 12 formed by such end cutting is shown in FIG. 5 with a cavity 16 extending through its full length 36. As will be appreciated, the cavity 16 of the die segment 12 will have an engineered cross-sectional profile 18, sized and shaped so as to be suitable to be made in a pultrusion process. Currently, wire cutting machines 38 are capable of end cutting blocks 34 having lengths 36 up to about 18 inches.

Although, a preferred embodiment of the present invention involves end cutting using wire cutting machines 38, which are known in the art as CNC Wirecut EDMs, other forms of end cutting are also contemplated by the present invention, including for example a hydro cutting machine (not shown). What is important is that the cutting machine 38 chosen is capable of cutting a cavity 16 into a block 34 by cutting from an end 40 of the block 34 and through the block, along an axis of the block.

It can now be understood, that the present invention provides a method of making pultrusion dies quickly and cheaply, as compared to the prior art. The instant invention permits the construction of a full length pultrusion die from a plurality of die segments stacked end to end, where each of the die segments are individually sized to permit end cutting along an axis of the block 34 using wire cutting machines 38 or the like. The die segments 12 formed from the blocks 34 are then aligned and secured to form the segmented pultrusion die 10.

The present invention comprehends being able to from a built up longer die from a plurality of shorter segments. The use of the shorter segments permits end cutting or longitudinal cutting of the individual segments, where the cutting action occurs along the same axis as the molded article is drawn or pulled. Due to the less expensive nature of such cutting than transverse grinding, different shapes and profiles can be tried and tested small changes made to improve the overall appearance of finished pultruded articles.

It is also contemplated that while one die segment is produced using the method of end cutting described above, other embodiments of the present invention may involve adjoining die segments formed using conventional die forming processes. What is important is that time and expense can be saved by forming at least a portion of the pultrusion die with a die segment prepared using an end cutting technique and adjoining it to at least one other die segment.

While reference has been made to various preferred embodiments of the invention other variations are comprehended by the broad scope of the appended claims. Some of these have been discussed in detail in this specification and others will be apparent to those skilled in the art. All such variations and alterations are comprehended by this specification are intended to be covered, without limitation.

The embodiments of the invention in which an exclusive property or privilege is claimed are defined as follows:

1. A method of making a segmented pultrusion die, said method comprising the steps of:
selecting a first block having a first length sized to permit end cutting along an axis of said first block;
end cutting said first block along said axis thereof, to form a first die segment having a first cavity extending therethrough, said first cavity having a first cross-sectional profile,
selecting a second block having a second length;
processing said second block to form a second die segment having a second cavity extending therethrough, said second cavity having a second cross-sectional profile which matches said first cross-sectional profile;
aligning said first and said second die segments together to match said first cross-sectional profile together with said second cross sectional profile to form a continuous die having a constant cross-sectional profile; and
securing said aligned first and second die segments together to permit said segmented pultrusion die to be used in place of a single die.

2. A method of making a segmented pultrusion die as claimed in claim 1 wherein said second length is sized to permit end cutting said second block along an axis thereof; and said step of processing said second block includes the step of end cutting said second block along said axis thereof to form said second die segment having said second cavity extending therethrough.

3. A method of making a segmented pultrusion die as claimed in claim 1 wherein said first length and/or said second length is less than or equal to 18 inches.

4. A method of making a segmented pultrusion die according to claim 1, wherein said first length and said second length are the same.

5. A method of making a segmented pultrusion die according to claim 1, wherein said first length and said second length are different.

6. A method of making a segmented pultrusion die according to claim 1, wherein at least one of said first and said second block is a metal block.

7. A method of making a segmented pultrusion die according to claim 6, wherein said metal block is steel.

8. A method of making a segmented pultrusion die according to claim 1, further comprising the steps of:
selecting a further block having a length sized to permit end cutting along an axis of said further block;
end cutting said further block along said axis thereof, to form a further die segment having a cavity extending therethrough, said cavity having a cross-sectional profile;
aligning said further die segment and said segmented pultrusion die to match said constant cross-sectional profile of said segmented pultrusion die; and
securing said aligned further die segment and said segmented pultrusion die together.

9. A method of making a segmented pultrusion die as claimed in claim 1, wherein said step of aligning said first and second die segments together includes the step of providing a first aperture on an end of said first die segment, and a second aperture on an end of said second die segment in matching relation to said first aperture, and positioning a pin between said first and second die segments to cooperate with said first and said second apertures.

10. A method of making a segmented pultrusion die as claimed in claim 1, wherein said step of aligning said first and second die segments together includes the step of providing at least one tongue member on said first die segment or said second die segment, and at least one cooperating groove on the other of said first die segment or said second die segment.

11. A method of making a segmented pultrusion die as claimed in claim 1, wherein said step of securing said first and said second die segments together includes the step of welding said first die segment to said second die segment.

12. A method of making a segmented pultrusion die as claimed in claim 1, wherein said step of securing said first and said second die segments together includes the step of bonding said first die segment to said second die segment using an adhesive.

13. A method of making a segmented pultrusion die as claimed in claim 1, wherein said step of securing said first and said second die segments together includes the step of securing at least one attachment member proximate to an end of either of said first die segment or said second die segment.

14. A method of making a segmented pultrusion die as claimed in claim 13, wherein said step of securing said at least one attachment member proximate to an end of either of said first die segment or said second die segment includes the step of using a threaded fastener or welding.

15. A method of making a segmented pultrusion die as claimed in claim 14, wherein said step of securing said first and said second die segments together further includes the step of securing said at least one attachment member proximate to an end of the other of said first or said second die segments with a threaded fastener or by welding.

16. A method of making a segmented pultrusion die as claimed in claim 1, wherein said step of securing said first and said second die segments together comprises the steps of:
providing a fastener having a head and a threaded shank;
securing at least one attachment member proximate to an end of either of said first or second die segments, said attachment member defining an aperture large enough to allow said shank, but not said head, of said threaded fastener to pass therethrough;
forming a threaded bore sized and shaped to cooperate with said threaded shank of said fastener on the other of said first or second die segments from said attachment member, in matching relation to said aperture, wherein when said first and said second die segments are aligned, said threaded bore is aligned with said aperture; and
securing said aligned first and second die segments together by securing said fastener through said aperture in said threaded bore.

17. A method of making a segmented pultrusion die as claimed in claim 1, wherein said step of securing said first and said second die segments together comprises the steps of:
providing a first member on said first die segment, said first member being positioned proximate to an end of said first die segment that is to be adjoined to said second die segment;
providing a second member on said second die segment, said second member being positioned proximate to an end of said second segment that is to be adjoined to said first segment;
axially forcing said first and second members towards one another.

18. A method of making a segmented pultrusion die as claimed in claim 17, wherein said first member includes a first opening, and said second member includes a second opening, and wherein said step of axially forcing said first and said second members towards one another employs a threaded fastener positioned through said first and second opening.

19. A method of making a segmented pultrusion die as claimed in claim 17, wherein said step of axially forcing said first and said second members towards one another employs a clamp.

20. A segmented pultrusion die made by the method of claim 1.

21. A segmented pultrusion die comprising:
a first die segment having a first cavity extending therethrough formed by end cutting a first block along an axis thereof; said first block having a first length sized to permit end cutting along said axis of said first block; said first cavity having a first cross-sectional profile;
a second die segment having a second cavity extending therethrough formed from a second block, wherein said second block has a second length, and wherein said second cavity has a second cross-sectional profile which is matches said first cross-sectional profile;
said first die segment being adjoined to said second die segment with said first and second cavities aligned to form a continuous die having a continuous cavity with a constant cross-sectional profile;
a means for securing said first die segment to said second die segment.

22. A segmented pultrusion die as claimed in claim 21, wherein said second die segment having said second cavity extending therethrough is formed by end cutting said second block along an axis thereof; said second length being sized to permit end cutting along said axis of said second block.

23. A segmented pultrusion die as claimed in claim 21, wherein said first length and/or said second length is less than or equal to 18 inches.

24. A segmented pultrusion die according to claim 21, wherein said first length and said second length are the same.

25. A segmented pultrusion die according to claim 21, wherein said first length and said second length are different.

26. A segmented pultrusion die according to claim 21, wherein at least one of said first and said second blocks is a metal block.

27. A segmented pultrusion die according to claim 26, wherein said metal block is steel.

28. A segmented pultrusion die according to claim 21, further comprising:
a further die segment having a cavity extending therethrough formed by end cutting a further block along an axis thereof; said further block having a length sized to permit end cutting along said axis of said further block; said first cavity having a cross-sectional profile; said further die segment and said segmented pultrusion die being secured together with said cavity and said continuous cavity aligned together to match said cross-sectional profile with said constant cross-sectional profile.

29. A segmented pultrusion die as claimed in claim 21, wherein said means for securing said first die segment and said second die segment together includes a means for aligning said first and second cavities.

30. A segmented pultrusion die as claimed in claim 29, wherein said means for aligning said first die segment and said second die segment together includes a first aperture on an end of said first die segment, and a second aperture on an end of said second die segment in matching relation to said first aperture, and a pin positioned between said first and second die segments to cooperate with said first and said second apertures.

31. A segmented pultrusion die as claimed in claim 29, wherein said means for aligning said first die segment and said second die segment together includes at least one tongue member on said first die segment or said second die segment, and at least one cooperating groove on the other of said first die segment or said second die segment.

32. A segmented pultrusion die as claimed in claim 21, wherein a means for securing said first die segment and said second die segment together comprises a weld joint between said first die segment and said second die segment.

33. A segmented pultrusion die as claimed in claim 21, wherein said means for securing said first die segment and said second die segment together comprises at least one attachment member.

34. A segmented pultrusion die as claimed in claim 33, wherein said attachment member includes an alignment portion to align said first and second die segments before said first and second die segments are secured together.

35. A segmented pultrusion die as claimed in claim 33, wherein said at least one attachment member is secured to both said first die segment and said second segment with threaded fasteners or by welding.

36. A segmented pultrusion die as claimed in claim 21, wherein said means for securing said segments together comprises:
a first attachment member located proximate to an end of one of said first segment or second segments,
a second attachment member located proximate to an end of said other segment, and
a means to axially force said first and second members towards one another.

37. A segmented pultrusion die as claimed in claim 36, wherein said means to axially force said first and second members towards one another comprises a threaded fastener.

38. A segmented pultrusion die as claimed in claim 21, wherein said means for securing said first die segment to said second die segment comprises at least one threaded fastener on one of said first or said second die segments, said threaded fastener being aligned with a corresponding threaded bore on the other of said first or said second die segment, said threaded bore being sized and shaped to cooperate with said threaded fastener.
